(19) United States
(12) Patent Application Publication
(10) Pub. No.: US 2008/0143231 A1
(43) Pub. Date: Jun. 19, 2008

(54) Base contact member for improved welding and associated method

(76) Inventors: Wayne D. Johnson, Chardon, OH (US); Jon Mallery, Medina, OH (US)

Correspondence Address: FAY SHARPE LLP, 1100 SUPERIOR AVENUE, SEVENTH FLOOR, CLEVELAND, OH, 44114, US

(21) Appl. No.: 11/584,689

(22) Filed: Oct. 20, 2006

(51) Int. Cl. H01J 5/48

(52) U.S. Cl. 313/318.01

(57) ABSTRACT

A new contact member is provided to establish intimate contact between a lead wire and the contact member of a lamp base. A flap is formed in a planar wall and connected to the body by a hinge region. The opening formed by the flap is dimensioned to freely receive the lead wire therethrough. The flap is then deflected along the hinge region to pinch the lead wire with the flap and assure continuity of a ground path during welding. The contact member is then grounded, and the welding electrode disposed adjacent an antenna of the lead wire extending outwardly from the contact member. Welding is preferably established by forming an arc between the welding electrode and the lead wire so that the lead wire is melted to form the weld with contact member.

### BACKGROUND OF THE INVENTION

This disclosure is related to a modified contact member or lug as used in a high output lamp base that improves the electrical connection of a lead wire to the contact member prior to welding the lead wire to the contact member.

U.S. Pat. No. 2,922,137 is commonly assigned to the assignee of the present application. A conventional lamp base such as a linear fluorescent lamp is disclosed in the '137 patent and includes a lamp envelope enclosing electrodes at opposite ends of a lamp cavity. A conventional fill gas is provided in the envelope and typically an inner surface includes a coating of a fluorescent material that is excited to luminescence by the emission of a low pressure vapor discharge during operation of the lamp. Of particular interest to the subject disclosure is the teaching in the '137 patent of the interconnection of a lead wire extending from the electrode for interconnection with an electrically conductive contact member received in a base of the lamp. The '137 patent teaches feeding a lead wire through a suitably dimensioned opening in the contact member. A preferred method of welding the wire and the contact member together is taught in commonly assigned U.S. Pat. No. 2,749,528, as identified in the '137 patent. Particularly, a conventional method of attachment feeds the contact member opening over the lead wire, and then the lead wire is cut to a predetermined length and deformed or bent over into abutting engagement with an edge of the lug opening. The '528 patent suggests rolling down an edge of the lead wire and then subsequently carrying out the welding operation by which the lead wire is fused to the contact member.

Although commercially successful, there is a need to improve the electrical connection of the lead wire to the contact member prior to lead wire welding. With a poor connection of the lead wire to the contact member, there is uncertainty whether the wire is enveloped and thus melted in the welding arc. Highly variable results in weld quality thus result due to the variations in the amount of metal in the weld connection. Poor connection between the lead wire and contact member also leads to the possibility of secondary arcs in the welding circuit that, in turn, provide variability in the heat balance in the weld, which also leads to highly variable welding quality.

Present methods of either bending the lead wire against the contact member or cold welding the lead wire to the contact member by physically hammering the wire against the edge of the contact member opening are deemed inadequate. Both of these methods create inconsistent contact. A TIG welding technique was considered for a time, however, that process required accurate positioning of the parts that was deemed beyond the mechanical capabilities of the welding machinery.

Thus, a need exists for an improved lug contact and lead wire interconnection in order to improve the continuity of the ground path during welding, and improve consistency and weld quality.

### BRIEF DESCRIPTION OF THE INVENTION

A contact member for use with an associated lamp having an associated lead wire extending from an associated light emitting element includes a body dimensioned for receipt in an associated lamp base. The body includes a first leg that is conformed for cooperation with an associated ground member of an associated welder, and a generally planar wall adjacent one end of the first leg having an opening therethrough.

A flap is deflected along a hinge region toward the generally planar wall to assure continuity of a ground path during welding.

A method of forming a lead wire interconnection with a contact member of an associated lamp includes providing a contact member having a flap that defines an opening therein. Further, a lead wire is fed through the contact member opening, cut to length, and the flap is deflected or deformed to urge the lead wire against the contact member. The contact member is subsequently grounded prior to welding the lead wire to the contact member.

### BRIEF DESCRIPTION OF THE DRAWINGS

FIG. 1 is a side elevational view of a discharge lamp provided with bases that relate to this disclosure.

FIG. 2 is a perspective view of a prior art contact member.

FIGS. 3-5 are cross-sectional views of one end of the lamp of FIG. 1, illustrating the prior art arrangement on the right-hand contact member and the new design of the present disclosure on the left-hand contact member, and the respective steps in forming the lead wire to contact member interconnection.

FIG. 6 is an elevational view of a preferred contact member or lug.

FIG. 7 is a side elevational view taken generally from the left-hand side of FIG. 6.

FIG. 8 is a top plan view of the contact member of FIG. 6.

### DETAILED DESCRIPTION OF THE INVENTION

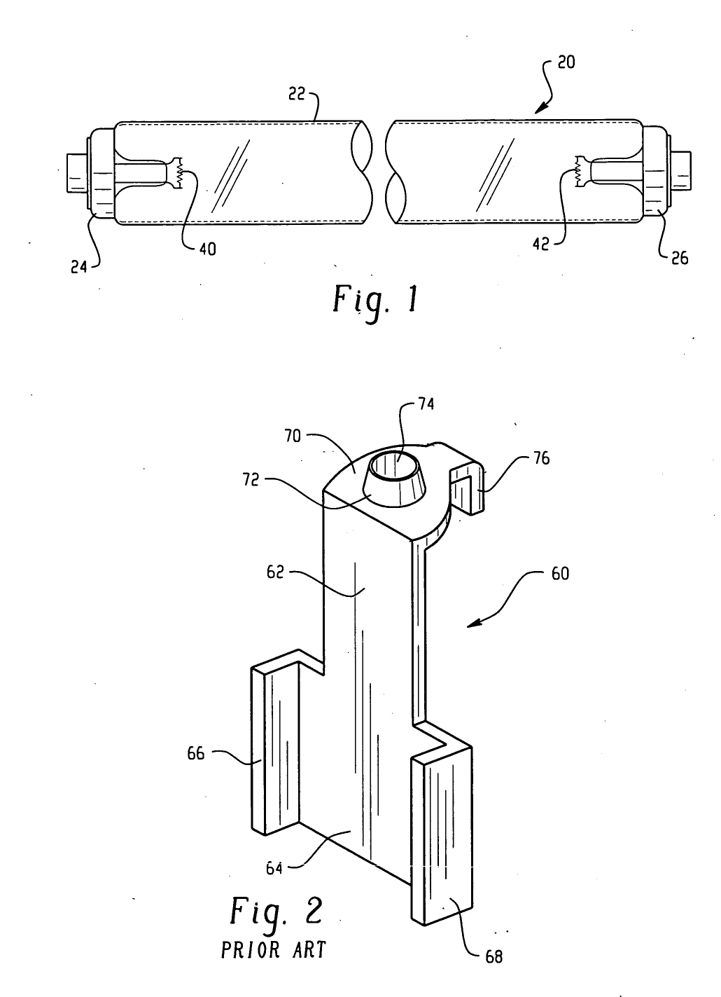

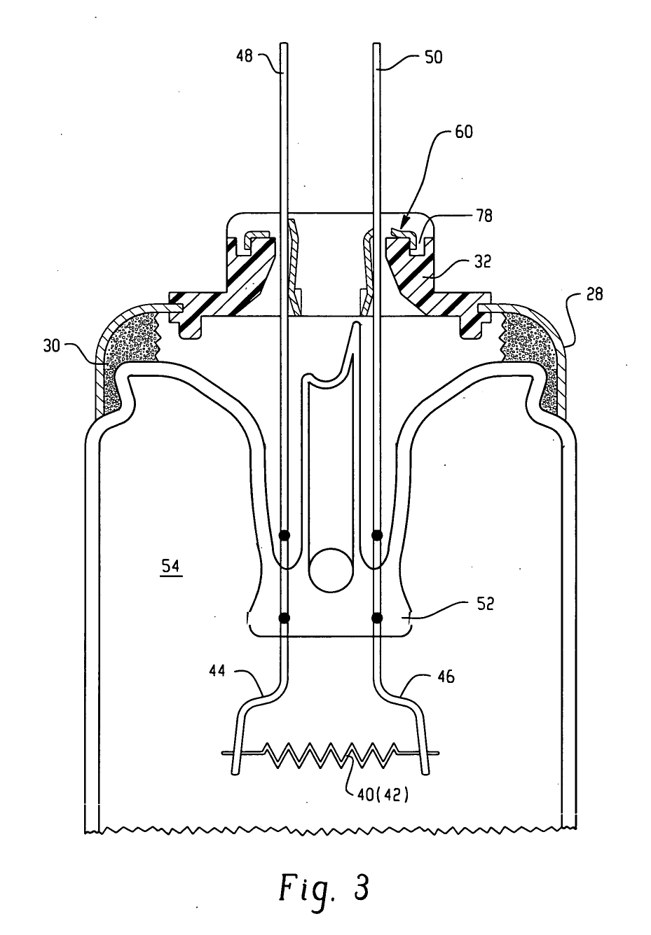

FIG. 1 shows a discharge lamp 20, and more particularly an elongated fluorescent lamp having a generally tubular envelope 22 closed at opposite ends by bases 24, 26. Typically the base is an annular metal shell 28 (FIG. 3) secured to an end of the lamp via a basing cement 30. Centrally located in the annular shell is a body member 32 formed of an electrically insulating material such as a plastic such that an inner rim or edge of the annular shell is embedded or molded into the body. First and second electrodes 40, 42 are spaced at opposite ends of the lamp and are of substantially identical construction. Each electrode is supported by inner ends 44, 46 of lead wires 48, 50, and the lead wires pass through a press seal region 52 of the envelope which seals the internal discharge chamber 54 and the enclosed fill of the lamp from the external environment.

With continued reference to FIGS. 1 and 3, and additional reference to FIG. 2, a prior art lug or contact member 60 is individually shown in FIG. 2, and generally illustrated in the right-hand portion of each of FIGS. 3-5. The prior art contact member is more particularly described in commonly owned U.S. Pat. No. 2,922,137, including an elongated flat portion 62 having a widened end 64 with a pair of parallel flanges 66, 68. An opposite end of the elongated portion 62 includes an end portion 70 having an upstanding eyelet 72 that incorporates an eyelet opening 74 dimensioned to receive the lead wire (shown as lead wire 50 in FIG. 30) therethrough. Tab 76 extends from the flat portion 70 and is received in a corresponding cavity or pocket 78 of the electrically insulated body 32.

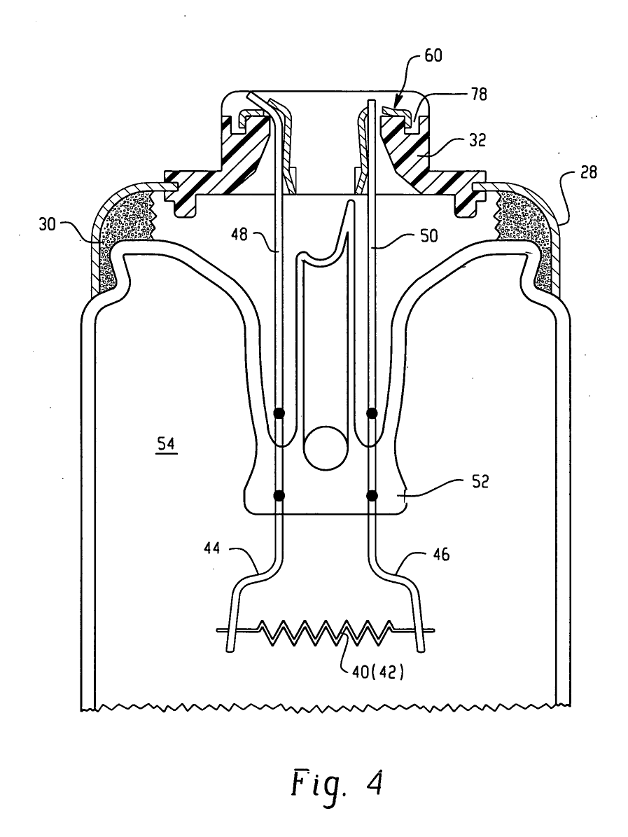

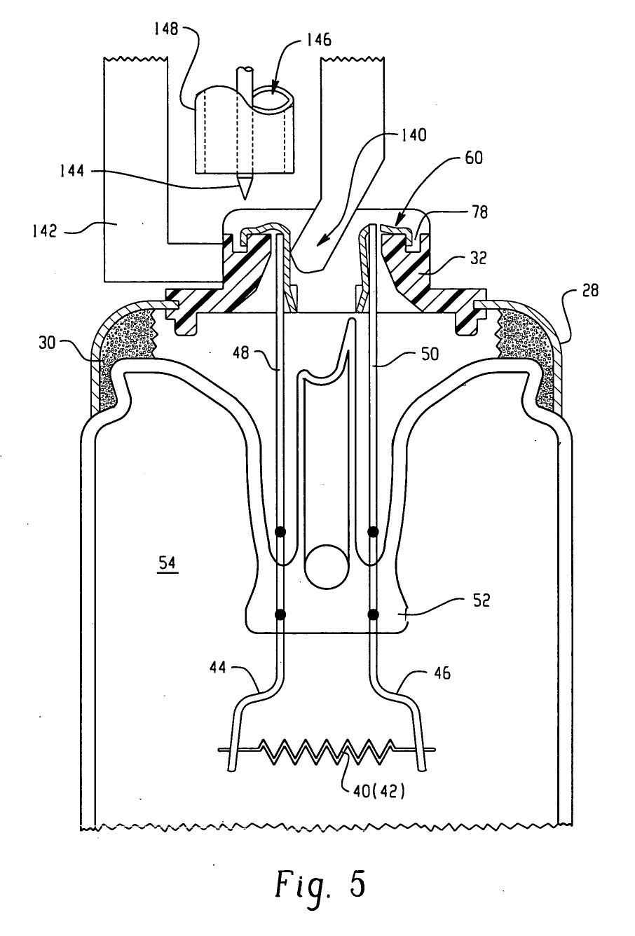

For reference purposes only, the wire is approximately 0.018 inches in diameter, and preferably formed from copper, while the lug or contact member 60 is preferably a brass material with an eyelet opening 74 of approximately 0.027 inches, although it will be understood that other dimensions or materials may be used without departing from the scope and intent of this disclosure. Thus, as shown in FIG. 3, the lead wires are typically fed through the eyelet openings of the contact member 60 and then trimmed to length as illustrated in the right-hand side of FIG. 4. Subsequently, the lead wire is welded to the contact member as shown in the right-hand side of FIG. 5. Again, details of that structure and method are taught in commonly owned U.S. Pat. No. 2,922,137, as well as commonly owned U.S. Pat. No. 2,749,528 identified therein.

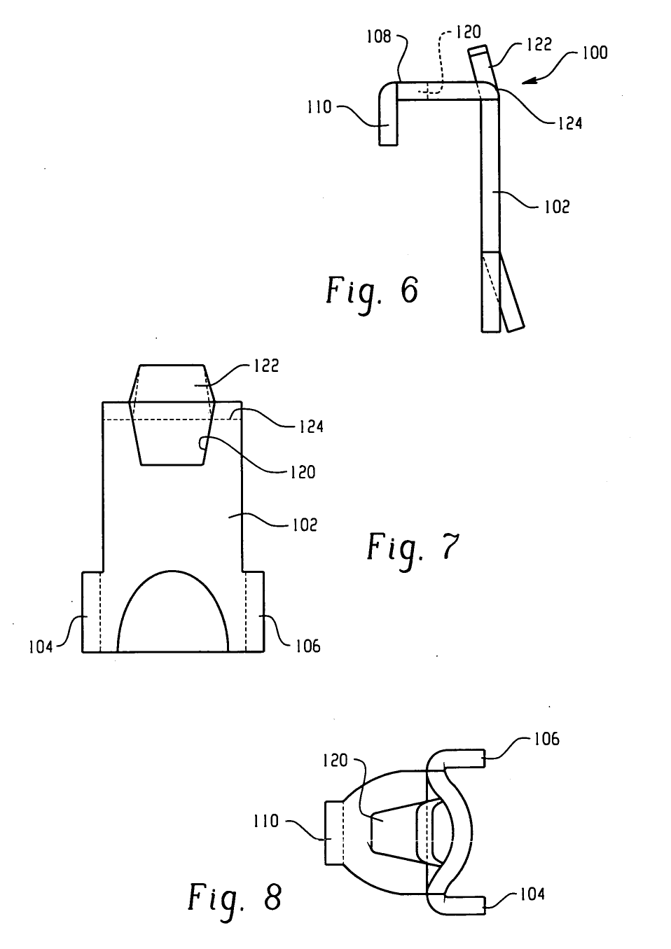

As noted in the Background section above, it is important during the welding process to achieve a more consistent electrical current path, i.e., assure continuity of a ground path. In the prior art arrangement, simple abutment of the lead wire with the contact member was relied upon to achieve the ground path. As more particularly illustrated in the left-hand portions of FIGS. 3-5, a modified contact member shown in FIGS. 6-8 improves the electrical connection of the lead wire to the contact member prior to welding. This improved contact allows for a more consistent electrical current path during welding, and also has the additional benefit of using significantly more wire as filler metal in the weld melt. As a result, higher quality and more consistent lead wire/contact member welds are obtained.

Contact member 100, sometimes referred to as a lug or body, includes an elongated, generally planar portion or first leg 102, having first and second flanges 104, 106 at a first or lower end thereof. At a second or upper end of the leg is provided a generally planar wall or end portion 108 that includes a downwardly extending tab 110 at an end opposite that of the first leg. An opening 120 is provided in the wall 108 formed by punching a flap or flange 122 and bending the flap outwardly from the remainder of the wall 108 along a hinge region 124 disposed at the interface of the first leg 102 and the wall 108.

The opening 120 in the new design of the contact member is substantially larger than eyelet opening 74 in the prior art contact member shown in FIG. 2. More particularly, the opening 120 is in the range of 0.060-0.080 inches, and is illustrated here is a generally D-shaped opening (FIG. 7) so that the lead wire is easily received through the opening 120 (FIG. 3). One skilled in the art, however, will realize that the flap and resultant opening can adopt a wide variety of conformations or shapes and need not be limited to the D-shaped conformation shown in the drawings.

Once the lead wire 48 is fed through the opening 120, the lead wire is cut to a predetermined length. Rather than cutting off the lead wire against the edge of the eyelet opening as was the case with the prior art arrangement (see right-hand portion of FIG. 4), the new design instead has a longer length or lead wire portion extending from the opening. Once the lead wire is cut, the flap 122 is then bent toward the generally planar surface 108 along the fold region 124 to pinch the lead wire against the opening of the contact member (FIG. 4). This assures that intimate contact between the wire and lug/contact member is achieved. This intimate contact or temporary connection between the lead wire and the contact member is obtained before the welding occurs. Unlike the prior art arrangement where it was unknown whether good contact was achieved, the contact member 100 provides a good pinch or clamp that forces the current to pass through the lead wire, assures that there is a good ground, and ultimately assures that the lead wire is intimately welded to the contact member.

As is shown in FIG. 4, once the lead wire is pinched by the flap against the contact member, a sufficient portion of the lead wire extends above the flap of the contact member and serves as an “antenna” to start the weld. As more particularly shown in FIG. 5, ground finger 140 is angled to engage the first leg 102 and in cooperation with clamp arm 142 establish intimate electrical contact between the finger and the contact member so that the contact member is properly grounded. A weld electrode, such as tungsten electrode tip 144, is positioned adjacent the outer terminal end of the lead wire “antenna”. An inert gas flow is provided through annular passageway 146 about the welding electrode 144 and the electrode is fire discharged to initiate an arc at the end of the lead wire antenna. The resulting plasma melts the lead wire extending above the flap back to the contact member and the melt forms an effective weld between the lead wire and the contact member. Use of an inert gas shield around the electrode provided by cylindrical passage 148 directs the inert gas about the pointed electrode so that the weld arc can be accurately started and directed toward the end of the lead wire antenna. In a preferred arrangement, the inert gas flow (such as argon) is fed through the annular passageway 146 and then shut off or terminated just prior to starting the arc through electrode tip 144. The inert gas flow has a tendency to quench the arc and can adversely impact the weld during short cycle welding. Therefore, improved weld results are achieved if the arc is established shortly after the inert gas flow is terminated (approximately fifty milliseconds after the inert gas flow is terminated) and where the arc has a short duration (also on the order of about fifty milliseconds). One skilled in the art will also appreciate that the lead wire and contact member could also be connected via soldering or brazing. Many of the benefits associated with the intimate contact between the contact member and the lead wire as described above would also be achieved with a solder or brazed interconnection.

This design eliminates poor temporary connection between the lead wire and the contact member prior to welding. The weld takes place by electrical discharge from the external electrode to the grounded contact member of the base and, as a result of the intimate connection contact between the lead wire and the contact member, the lead wire is melted in the arc more consistently. Since the connections between the lead wire and the contact member are improved, the possibility of secondary arcs in the welding circuit that could potentially lead to variability in the heat balance in the weld is also reduced.

To summarize, the use of a larger opening in the contact member facilitates threading of the lead wire through the contact member opening. A flap around the opening will allow subsequent closure and pinching of the lead wire to an edge of the opening and assure desired, consistent electrical contact between the components. The lead wire is trimmed to a desired length to extend outwardly from the contact member. Since the contact member is effectively grounded, the electrode of the welder will more consistently initiate an arc at the end of the wire. Likewise, the heat of the arc will melt the wire back to the contact member, and in the presence of a shield gas, the melted wire will form a consistently strong weld to the contact member. This results in significantly improved yields and also lower costs in the factory.

A method of forming a high quality interconnection of the lead wire with a contact member includes the step of providing a contact member having a flap that defines an opening in the contact member. Subsequently, the lead wire of the associated lamp is fed through the contact member opening, and the lead wire is cut to a desired length. The flap is subsequently deformed or folded along the hinge region to pinch the lead wire against the contact member with the flap. Leaving a predetermined length of lead wire to serve as an antenna provides sufficient filler metal one the welding step is complete. That is, once the lead wire is pinched by the flap against the contact member, the contact member is grounded by applying a grounding clamp of an associated welder to the contact member. An inert gas is introduced adjacent a welding electrode, and an arc established with the end of the lead wire so that the lead wire is melted to perform an effective weld with the contact member.

The invention has been described with reference to the preferred embodiments. Obviously, modifications and alterations will occur to others upon reading and understanding the preceding detailed description. It is intended that the invention be construed as including all such modifications and alterations.

What is claimed is:

1. A contact member for use in an associated lamp having an associated lead wire extending from an associated light emitting element, the contact member comprising:
a body dimensioned for receipt in an associated lamp base, the body including a first leg having a conformation for operative cooperation with an associated ground member of an associated welder; and
a generally planar wall located adjacent one end of the first leg and including an opening therethrough, the planar wall including a flap connected by a hinge region to the generally planar wall and extending outwardly therefrom to define an opening dimensioned to receive an associated lead wire therethrough, the flap capable of deflection along the hinge region toward the generally planar wall subsequent to receipt of the associated lead wire to pinch the lead wire with the flap and assure continuity of a ground path during welding.

2. The contact member of claim 1 wherein the contact member is metal.

3. The contact member of claim 2 wherein the metal is brass.

4. The contact member of claim 1 wherein the hinge region of the flap is located at an interface of the generally planar wall with the first leg.

5. The contact member of claim 1 wherein the opening has a generally D-shape formed by separation of the flap from the generally planar wall.

6. The contact member of claim 1 wherein the first leg is substantially planar.

7. The contact member of claim 1 wherein the flap is generally aligned with the first leg prior to receipt of the associated lead wire through the opening, and subsequently bent along the hinge region to pinch the associated lead wire between the flap and the generally planar wall.

8. The contact member of claim 1 in combination with a lamp having an envelope containing a fill, a first filament, and first and second lead wires extending from opposite ends of the filament, each lead wire received through a respective contact member.

9. The contact member of claim 8 further comprising a second filament received in the envelope at a location spaced from the first filament.

10. A method of forming an interconnection of a lead wire with a contact member of an associated lamp, comprising
providing a contact member having a flap therein that defines an opening in the contact member;
feeding the lead wire of the associated lamp through the contact member opening;
cutting the lead wire; and
deforming the flap to urge the lead wire against the contact member.

11. The method of claim 10 wherein the cutting step is performed before the deforming step.

12. The method of claim 10 wherein the deforming step includes folding the flap along a hinge region to pinch the lead wire with the flap.

13. the method of claim 10 wherein the cutting step includes leaving a predetermined length of lead wire to provide sufficient filler metal once the welding step is complete.

14. The method of claim 10 wherein the forming step includes punching the flap from the contact member and folding the flap away from the contact member along a hinge region to define an opening dimensioned to receive the lead wire therethrough.

15. The method of claim 14 wherein the deforming step includes folding the flap connected to the contact member along the hinge region to pinch the lead wire against the contact member.

16. The method of claim 10 further comprising one of brazing, soldering, and welding the lead wire to the contact member.

17. The method of claim 16 further comprising grounding the contact member prior to the welding step.

18. The method of claim 17 wherein the grounding step includes applying a grounding clamp of an associated welder to the contact member.

19. The method of claim 16 wherein the welding step includes introducing an inert gas adjacent a welding electrode positioned near the lead wire.

20. The method of claim 19 wherein the inert gas flow is terminated just prior to forming an arc between the welding electrode and the lead wire.
